(19) United States
(12) Patent Application Publication
(10) Pub. No.: US 2023/0041242 A1
(43) Pub. Date: Feb. 9, 2023

(54) PERFORMING NETWORK CONGESTION CONTROL UTILIZING REINFORCEMENT LEARNING

(71) Applicant: NVIDIA Corporation, Santa Clara, CA (US)

(72) Inventors: Shie Mannor, Haifa (IL); Chen Tessler, Haifa (IL); Yuval Shpigelman, Netanya (IL); Amit Mandelbaum, Teqoa (IL); Gal Dalal, Haifa (IL); Doron Kazakov, Jerusalem (IL); Benjamin Fuhrer, Tel Aviv (IL)

(21) Appl. No.: 17/959,042

(22) Filed: Oct. 3, 2022

Related U.S. Application Data
(62) Division of application No. 17/341,210, filed on Jun. 7, 2021.
(60) Provisional application No. 63/139,708, filed on Jan. 20, 2021.

(51) Int. Cl. H04L 43/0817; H04L 43/067; H04L 43/0852; G06N 3/08; H04L 47/122; G06K 9/62; H04L 43/0882

(52) U.S. Cl. CPC H04L 43/0817; H04L 43/067; H04L 43/0852; G06N 3/08; H04L 47/122; G06K 9/6262; H04L 43/0882

(57) ABSTRACT

A reinforcement learning agent learns a congestion control policy using a deep neural network and a distributed training component. The training component enables the agent to interact with a vast set of environments in parallel. These environments simulate real world benchmarks and real hardware. During a learning process, the agent learns how maximize an objective function. A simulator may enable parallel interaction with various scenarios. As the trained agent encounters a diverse set of problems it is more likely to generalize well to new and unseen environments. In addition, an operating point can be selected during training which may enable configuration of the required behavior of the agent.

### CLAIM OF PRIORITY

This application is a divisional of U.S. application Ser. No. 17/341,210, filed Jun. 7, 2021, which claims the benefit of U.S. Provisional Application No. 63/139,708, filed on Jan. 20, 2021, the entire content of which are hereby incorporated by reference in their entirety.

### FIELD OF THE INVENTION

The present disclosure relates to performing network congestion control.

### BACKGROUND

Network congestion occurs in computer networks when a node (network interface card (NIC) or router/switch) in the network receives traffic at a faster rate than it can process or transmit it. Congestion leads to increased latency (time for information to travel from source to destination) and at the extreme case may also lead to packets dropped/lost or head-of-the-line blocking.

Current congestion control methods rely on manually-crafted algorithms. These hand-crafted algorithms are very hard to adjust, and it is difficult to implement a single configuration that works on a diverse set of problems. Current methods also do not address complex multi-host scenarios in which the transmission rate of a different NIC may have dramatic effects on the congestion observed.

### BRIEF DESCRIPTION OF THE DRAWINGS

FIG. 1 illustrates a flowchart of a method of performing congestion control utilizing reinforcement learning, in accordance with an embodiment.

FIG. 2 illustrates a flowchart of a method of training and deploying a reinforcement learning agent, in accordance with an embodiment.

FIG. 3 illustrates an exemplary reinforcement learning system, in accordance with an embodiment.

FIG. 4 illustrates a network architecture, in accordance with an embodiment.

FIG. 5 illustrates an exemplary system, in accordance with an embodiment.

FIG. 6 illustrates an exemplary system diagram for a game streaming system, in accordance with an embodiment.

FIG. 7 illustrates an exemplary congestion point in a network, in accordance with an embodiment.

### DETAILED DESCRIPTION

An exemplary system includes an algorithmic learning agent that learns a congestion control policy using a deep neural network and a distributed training component. The training component enables the agent to interact with a vast set of environments in parallel. These environments simulate real world benchmarks and real hardware.

The process has two parts—learning and deployment. During learning, the agent interacts with the simulator and learns how to act, based on the maximization of an objective function. The simulator enables parallel interaction with various scenarios (many to one, long short, all to all, etc.). As the agent encounters a diverse set of problems it is more likely to generalize well to new and unseen environments. In addition, the operating point (objective) can be selected during training, enabling per-customer configuration of the required behavior.

Once training has completed, this trained neural network is used to control the transmission rates of the various applications transmitting through each network interface card.

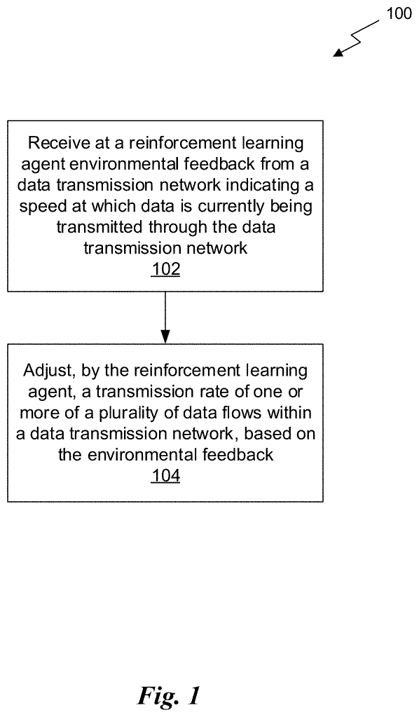

FIG. 1 illustrates a flowchart of a method 100 of performing congestion control utilizing reinforcement learning, in accordance with an embodiment. The method 100 may be performed the context of a processing unit and/or by a program, custom circuitry, or by a combination of custom circuitry and a program. For example, the method 100 may be executed by a GPU (graphics processing unit), CPU (central processing unit), or any processor described below. Furthermore, persons of ordinary skill in the art will understand that any system that performs method 100 is within the scope and spirit of embodiments of the present disclosure.

As shown in operation 102, environmental feedback is received at a reinforcement learning agent from a data transmission network, the environmental feedback indicating a speed at which data is currently being transmitted through the data transmission network. In one embodiment, the environmental feedback may be retrieved in response to establishing, by the reinforcement learning agent, an initial transmission rate of each of the plurality of data flows within the data transmission network. In another embodiment, the environmental feedback may include signals from the environment, or estimations thereof, or predictions of the environment.

Additionally, in one embodiment, the data transmission network may include one or more sources of transmitted data (e.g., data packets, etc.). For example, the data transmission network may include a distributed computing environment. In another example, ray tracing computations may be performed remotely (e.g., at one or more servers, etc.), and results of the ray tracing may be sent to one or more clients via the data transmission network.

Further, in one embodiment, the one or more sources of transmitted data may include one or more network interface cards (NICs) located on one or more computing devices. For example, one or more applications located on the one or more computing devices may each utilize one or more of the plurality of NICs to communicate information (e.g., data packets, etc.) to additional computing devices via the data transmission network.

Further still, in one embodiment, each of the one or more NICs may implement one or more of a plurality of data flows within the data transmission network. In another embodiment, each of the plurality of data flows may include a transmission of data from a source (e.g., a source NIC) to a destination (e.g., a switch, a destination NIC, etc.). For example, one or more of the plurality of data flows may be sent to the same destination within the transmission network. In another example, one or more switches may be implemented within the data transmission network.

Also, in one embodiment, the transmission rate for each of the plurality of data flows may be established by the reinforcement learning agent located on each of the one or more sources of communications data (e.g., each of the one or more NICs, etc.). For example, the reinforcement learning agent may include a trained neural network.

In addition, in one embodiment, an instance of a single reinforcement learning agent may be located on each source and may adjust a transmission rate of each of the plurality of data flows. For example, each of the plurality of data flows may be linked to an associated instance of a single reinforcement learning agent. In another example, each instance of the reinforcement learning agent may dictate the transmission rate of its associated data flow (e.g., according to a predetermined scale, etc.) in order to perform flow control (e.g., by implementing a rate threshold on the associated data flow, etc.).

Furthermore, in one example, by controlling the transmission rate of each of the plurality of data flows, the reinforcement learning agent may control the rate at which one or more applications transmit data. In another example, the reinforcement learning agent may include a machine learning environment (e.g., a neural network, etc.).

Further still, in one embodiment, the environmental feedback may include measurements extracted by the reinforcement learning agent from data packets (e.g., RTT packets, etc.) sent within the data transmission network. For example, the data packets from which the measurements are extracted may be included within the plurality of data flows.

Also, in one embodiment, the measurements may include a state value indicating a speed at which data is currently being transmitted within the transmission network. For example, the state value may include an RTT inflation value that includes a ratio of a current packet rate of the data current transmission network packets to a packet rate of an empty data transmission network. In another embodiment, the measurements may also include statistics derived from signals implemented within the data transmission network. For example, the statistics may include one or more of latency measurements, congestion notification packets, transmission rate, etc.

Additionally, as shown in operation 104, the transmission rate of one or more of a plurality of data flows within a data transmission network is adjusted by the reinforcement learning agent, based on the environmental feedback. In one embodiment, the reinforcement learning agent may include a trained neural network that takes the environmental feedback as input and outputs adjustments to be made to one or more of the plurality of data flows, based on the environmental feedback.

For example, the neural network may be trained using training data specific to the data transmission network. In another example, the training data may account for a specific configuration of the data transmission network (e.g., a number and location of one or more switches, a number of sending and receiving NICs, etc.).

Further, in one embodiment, the trained neural network may have an associated objective. For example, the associated objective may be to adjust one or more data flows such that all data flows within the data transmission network are transmitting at equal rates, while maximizing a utilization of the data transmission network and avoiding congestion within the data transmission network. In another example, congestion may be avoided by minimizing a number of dropped data packets within the plurality of data flows.

Further still, in one embodiment, the trained neural network may output adjustments to be made to one or more of the plurality of data flows in order to maximize the associated objective. For example, the reinforcement learning agent may establish a predetermined threshold bandwidth. In another example, data flows transmitting at a rate above the predetermined threshold bandwidth may be decreased by the reinforcement learning agent. In yet another example, data flows transmitting at a rate below the predetermined threshold bandwidth may be increased by the reinforcement learning agent.

Also, in one embodiment, a granularity of the adjustments made by the reinforcement learning agent may be configured/adjusted during a training of the neural network included within the reinforcement learning agent. For example, a size of adjustments made to data flows may be adjusted, where larger adjustments may reach the associated objective in a shorter time period (e.g., with less latency), while producing less equity between data flows, and smaller adjustments may reach the associated objective in a longer time period (e.g., with more latency), while producing greater equity between data flows. In another example, in response to the adjusting, additional environmental feedback may be received and utilized to perform additional adjustments. In another embodiment, the reinforcement learning agent may learn a congestion control policy, and the congestion control policy may be modified in reaction to observed data.

In this way, reinforcement learning may be applied to a trained neural network to dynamically adjust data flows within a data transmission network to minimize congestion while implementing fairness within data flows. This may enable congestion control within the data transmission network while treating all data flows in an equitable fashion (e.g., so that all data flows are transmitting at the same rate or similar rates within a predetermined threshold). Additionally, the neural network may be quickly trained to optimize a specific data transmission network. This may avoid costly, time-intensive manual network configurations, while optimizing the data transmission network, which in turn improves a performance of all devices communicating information utilizing the transmission network.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

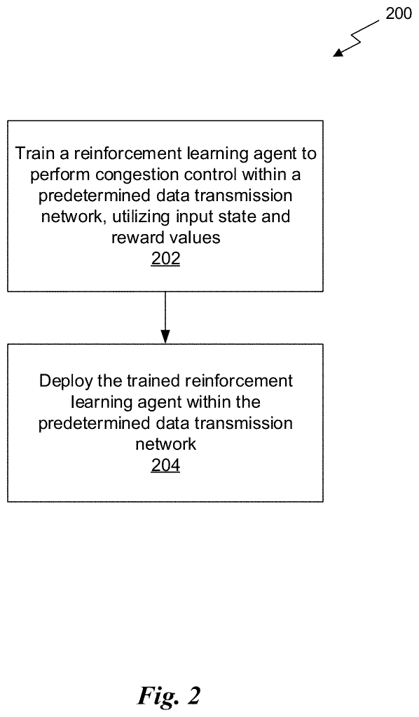

FIG. 2 illustrates a flowchart of a method 200 of training and deploying a reinforcement learning agent, in accordance with an embodiment. The method 200 may be performed the context of a processing unit and/or by a program, custom circuitry, or by a combination of custom circuitry and a program. For example, the method 200 may be executed by a GPU (graphics processing unit), CPU (central processing unit), or any processor described below. Furthermore, persons of ordinary skill in the art will understand that any system that performs method 200 is within the scope and spirit of embodiments of the present disclosure.

As shown in operation 202, a reinforcement learning agent is trained to perform congestion control within a predetermined data transmission network, utilizing input state and reward values. In one embodiment, the reinforcement learning agent may include a neural network that is trained utilizing the state and reward values. In another embodiment, the state values may indicate a speed at which data is currently being transmitted within the data transmission network. For example, the state values may correspond to a specific configuration of the data transmission network (e.g., a predetermined number of data flows going to a single destination, a predetermined number of network switches, etc.). In yet another embodiment, the reinforcement learning agent may be trained utilizing a memory.

Additionally, in one embodiment, the reward values may correspond to an equivalence of a rate of all transmitting data flows and an avoidance of congestion. In another embodiment, the neural network may be trained to optimize the cumulative reward values (e.g., by maximizing the equivalence of all transmitting data flows while minimizing congestion), based on the state values. In yet another embodiment, training the reinforcement learning agent may include developing a mapping between the input state values and output adjustment values (e.g., transmission rate adjustment values for each of a plurality of data flows within the data transmission network, etc.).

Further, in one embodiment, a granularity of the adjustments may be adjusted during the training. In another embodiment, the training may be based on a predetermined arrangement of hardware within the data transmission network. In yet another embodiment, multiple instances of the reinforcement learning agent may be trained in parallel to perform congestion control within a variety of different predetermined data transmission networks.

Also, in one embodiment, online learning may be used to learn a congestion control policy on-the-fly. For example, the neural network may be trained utilizing training data obtained from one or more external online sources.

Further still, as shown in operation 204, the trained reinforcement learning agent is deployed within the predetermined data transmission network. In one embodiment, the trained reinforcement learning agent may be installed within a plurality of sources of communications data within the data transmission network. In another embodiment, the trained reinforcement learning agent may receive as input environmental feedback from the predetermined data transmission network, and may control a transmission rate of one or more of a plurality of data flows from the plurality of sources of communications data within the data transmission network.

In this way, the reinforcement learning agent may be trained to react to rising/dropping congestion by adjusting transmission rates while still implementing fairness between data flows. Additionally, training a neural network may require less overhead when compared to manually solving congestion control issues within a predetermined data transmission network.

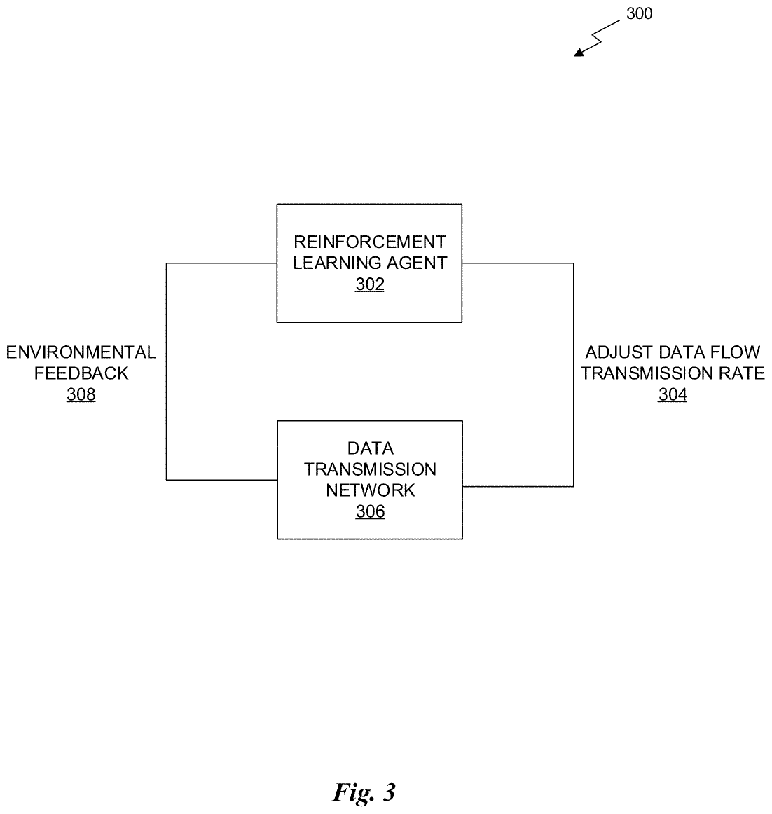

FIG. 3 illustrates an exemplary reinforcement learning system 300, according to one exemplary embodiment. As shown, a reinforcement learning agent 302 adjusts a transmission rate 304 of one or more data flows within a data transmission network 306. In response to those adjustments, environmental feedback 308 is retrieved and sent to the reinforcement learning agent 302.

Additionally, the reinforcement learning agent 302 further adjusts the transmission rate 304 of the one or more data flows within the data transmission network 306, based on the environmental feedback 308. These adjustments may be made to obtain one or more goals (e.g., equalizing a transmission rate of all data flows while minimizing congestion within the data transmission network 306, etc.).

In this way, reinforcement learning may be used to progressively adjust data flows within the data transmission network to minimize congestion while implementing fairness within data flows.

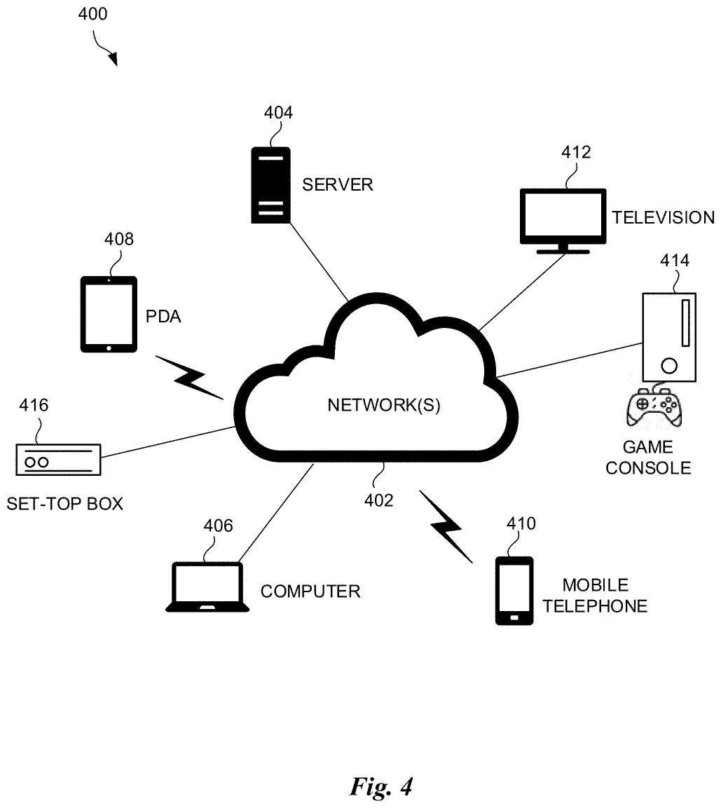

FIG. 4 illustrates a network architecture 400, in accordance with one possible embodiment. As shown, at least one network 402 is provided. In the context of the present network architecture 400, the network 402 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 402 may be provided.

Coupled to the network 402 is a plurality of devices. For example, a server computer 404 and an end user computer 406 may be coupled to the network 402 for communication purposes. Such end user computer 406 may include a desktop computer, lap-top computer, and/or any other type of logic. Still yet, various other devices may be coupled to the network 402 including a personal digital assistant (PDA) device 408, a mobile phone device 410, a television 412, a game console 414, a television set-top box 416, etc.

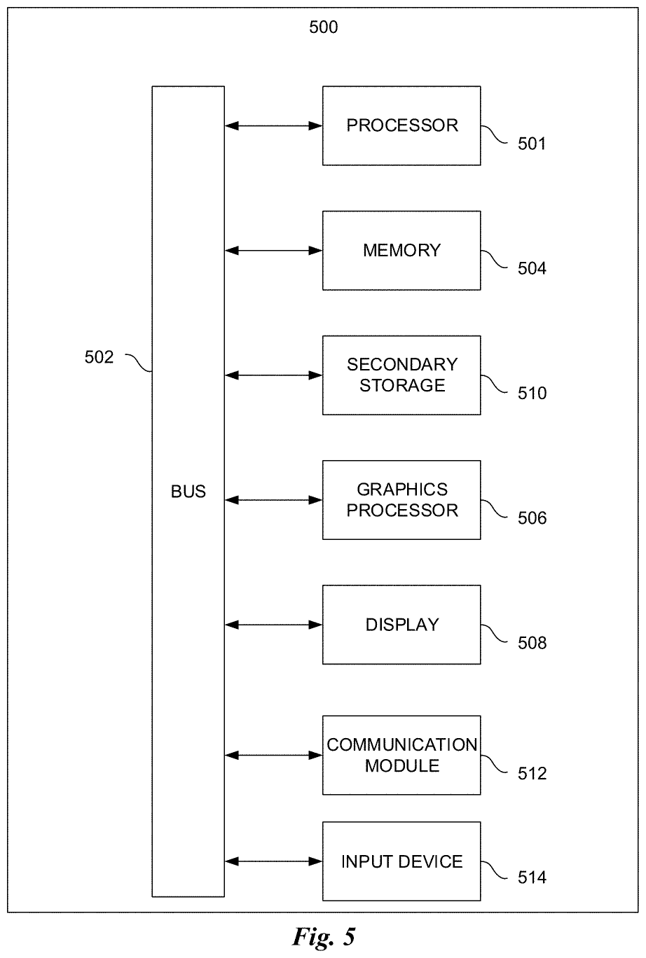

FIG. 5 illustrates an exemplary system 500, in accordance with one embodiment. As an option, the system 500 may be implemented in the context of any of the devices of the network architecture 400 of FIG. 4. Of course, the system 500 may be implemented in any desired environment.

As shown, a system 500 is provided including at least one central processor 501 which is connected to a communication bus 502. The system 500 also includes main memory 504 [e.g. random access memory (RAM), etc.]. The system 500 also includes a graphics processor 506 and a display 508.

The system 500 may also include a secondary storage 510. The secondary storage 510 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 504, the secondary storage 510, and/or any other memory, for that matter. Such computer programs, when executed, enable the system 500 to perform various functions (as set forth above, for example). Memory 504, storage 510 and/or any other storage are possible examples of non-transitory computer-readable media.

The system 500 may also include one or more communication modules 512. The communication module 512 may be operable to facilitate communication between the system 500 and one or more networks, and/or with one or more devices through a variety of possible standard or proprietary communication protocols (e.g. via Bluetooth, Near Field Communication (NFC), Cellular communication, etc.).

As also shown, the system 500 may include one or more input devices 514. The input devices 514 may be wired or wireless input device. In various embodiments, each input device 514 may include a keyboard, touch pad, touch screen, game controller (e.g. to a game console), remote controller (e.g. to a set-top box or television), or any other device capable of being used by a user to provide input to the system 500.

Example Game Streaming System

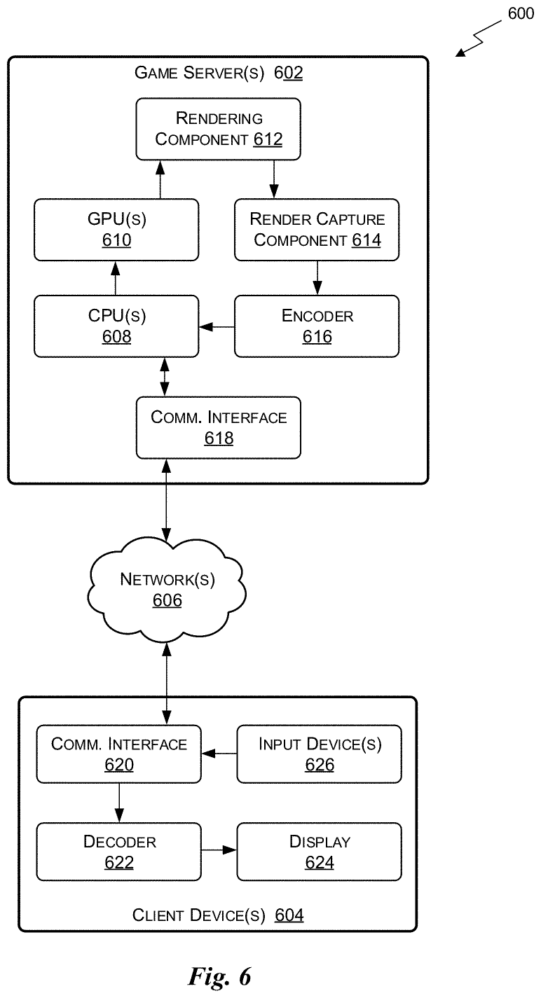

Now referring to FIG. 6, FIG. 6 is an example system diagram for a game streaming system 600, in accordance with some embodiments of the present disclosure. FIG. 6 includes game server(s) 602 (which may include similar components, features, and/or functionality to the example system 500 of FIG. 5), client device(s) 604 (which may include similar components, features, and/or functionality to the example system 500 of FIG. 5), and network(s) 606 (which may be similar to the network(s) described herein). In some embodiments of the present disclosure, the system 600 may be implemented.

In the system 600, for a game session, the client device(s) 604 may only receive input data in response to inputs to the input device(s), transmit the input data to the game server(s) 602, receive encoded display data from the game server(s) 602, and display the display data on the display 624. As such, the more computationally intense computing and processing is offloaded to the game server(s) 602 (e.g., rendering—in particular ray or path tracing—for graphical output of the game session is executed by the GPU(s) of the game server(s) 602). In other words, the game session is streamed to the client device(s) 604 from the game server(s) 602, thereby reducing the requirements of the client device(s) 604 for graphics processing and rendering.

For example, with respect to an instantiation of a game session, a client device 604 may be displaying a frame of the game session on the display 624 based on receiving the display data from the game server(s) 602. The client device 604 may receive an input to one of the input device(s) and generate input data in response. The client device 604 may transmit the input data to the game server(s) 602 via the communication interface 620 and over the network(s) 606 (e.g., the Internet), and the game server(s) 602 may receive the input data via the communication interface 618. The CPU(s) may receive the input data, process the input data, and transmit data to the GPU(s) that causes the GPU(s) to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the game server(s) 602. The encoder 616 may then encode the display data to generate encoded display data and the encoded display data may be transmitted to the client device 604 over the network(s) 606 via the communication interface 618. The client device 604 may receive the encoded display data via the communication interface 620 and the decoder 622 may decode the encoded display data to generate the display data. The client device 604 may then display the display data via the display 624.

Reinforcement Learning for Datacenter Congestion Control

In one embodiment, the task of network congestion control in datacenters may be addressed using reinforcement learning (RL). Successful congestion control algorithms can dramatically improve latency and overall network throughput. However, current deployment solutions rely on manually created rule-based heuristics that are tested on a predetermined set of benchmarks. Consequently, these heuristics do not generalize well to new scenarios.

In response, an RL-based algorithm may be provided which generalizes to different configurations of real-world datacenter networks. Challenges such as partial-observability, non-stationarity, and multi-objectiveness may be addressed. A policy gradient algorithm may also be used that leverages the analytical structure of the reward function to approximate its derivative and improve stability.

At a high level, congestion control (CC) may be viewed as a multi-agent, multi-objective, partially observed problem where each decision maker receives a goal (target). The target enables tuning of behavior to fit the requirements (i.e., how latency-sensitive the system is). The target may be created to implement beneficial behavior in the multiple considered metrics, without having to tune coefficients of multiple reward components. The task of datacenter congestion control may be structured as a reinforcement learning problem. An on-policy deterministic-policy-gradient scheme may be used that takes advantage of the structure of a target-based reward function. This method enjoys both the stability of deterministic algorithms and the ability to tackle partially observable problems.

In one embodiment, the problem of datacenter congestion control may be formulated as a partially-observable multi-agent multi-objective RL task. A novel on-policy deterministic-policy-gradient method may solve this realistic problem. An RL training and evaluation suite may be provided for training and testing RL agents within a realistic simulator. It may also be ensured that the agent satisfies compute and memory constraints such that it can be deployed in future datacenter network devices.

Networking Preliminaries

In one embodiment, within datacenters, traffic contains multiple concurrent data streams transmitting at high rates. The servers, also known as hosts, are interconnected through a topology of switches. A directional connection between two hosts that continuously transmits data is called a flow. In one embodiment, it may be assumed that the path of each flow is fixed.

Each host can hold multiple flows whose transmission rates are determined by a scheduler. The scheduler iterates in a cyclic manner between the flows, also known as round-robin scheduling. Once scheduled, the flow transmits a burst of data. The burst's size generally depends on the requested transmission rate, the time it was last scheduled, and the maximal burst size limitation.

A flow's transmission is characterized by two primary values: (1) bandwidth, which indicates the average amount of data transmitted, measured in Gbit per second; and (2) latency, which indicates the time it takes for a packet to reach its destination. Round-trip-time (RTT) measures the latency from the source, to the destination, and back to the source. While the latency is often the metric of interest, many systems are only capable of measuring RTT.

Congestion Control

Congestion occurs when multiple flows cross paths, transmitting data through a single congestion point (switch or receiving server) at a rate faster than the congestion point can process. In one embodiment, it may be assumed that all connections have equal transmission rates, as typically occurs in most datacenters. Thus, a single flow can saturate an entire path by transmitting at the maximal rate.

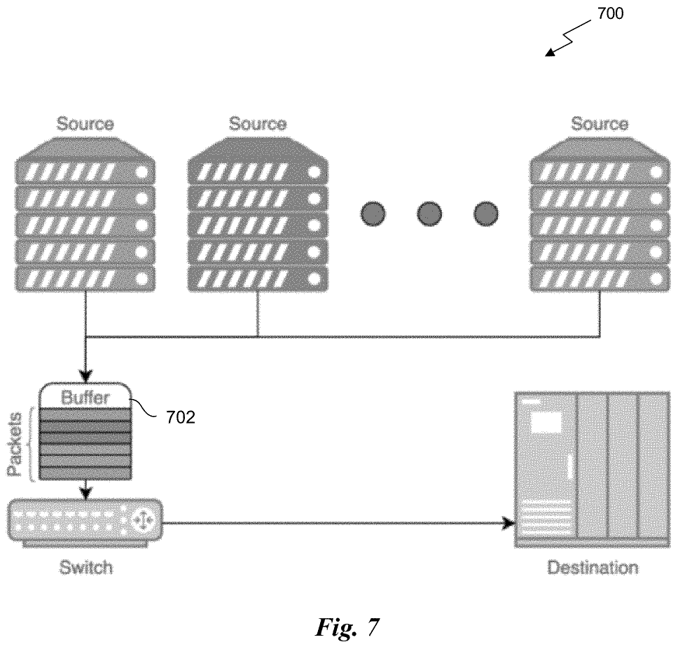

As shown in FIG. 7, each congestion point in the network 700 has an inbound buffer 702, enabling it to cope with short periods where the inbound rate is higher than it can process. As this buffer 702 begins to fill, the time (latency) it takes for each packet to reach its destination increases. When the buffer 702 is full, any additional arriving packets are dropped.

Congestion Indicators

There are various methods to measure or estimate the congestion within a network. For example, an explicit congestion notification (ECN) protocol considers marking packets with an increasing probability as the buffer fills up. Network telemetry is an additional, advanced, congestion signal. As opposed to statistical information (ECN), a telemetry signal is a precise measurement provided directly from the switch, such as the switch's buffer and port utilization.

However, while the ECN and telemetry signals provide useful information, they require specialized hardware. One implementation that may be easily deployed within existing networks are based on RTT measurements. They measure congestion by comparing the RTT to that of an empty system.

Objective

In one embodiment, CC may be seen as a multi-agent problem. Assuming there are N flows, this results in N CC algorithms (agents) operating simultaneously. Assuming all agents have an infinite amount of traffic to transmit, their goal is to optimize the following metrics:

1. Switch bandwidth utilization—the % from maximal transmission rate.

2. Packet latency—the amount of time it takes for a packet to travel from the source to its destination.

3. Packet-loss—the amount of data (% of maximum transmission rate) dropped due to congestion.

4. Fairness—a measure of similarity in the transmission rate between flows sharing a congested path.

$$\frac{{min}_{flows} BW}{{max}_{flows} BW} ∈ [ 0 , 1 ]$$

is an exemplary consideration.

One exemplary multi-objective problem of the CC agent is to maximize the bandwidth utilization and fairness, and minimize the latency and packet-loss. Thus, it may have a Pareto-front for which optimality with respect to one objective may result in sub-optimality of another. However, while the metrics of interest are clear, the agent does not necessarily have access to signals representing them. For instance, fairness is a metric that involves all flows, yet the agent observes signals relevant only to the flow it controls. As a result, fairness is reached by setting each flow's individual target adaptively, based on known relations between its current RTT and rate.

Additional complexities are addressed. As the agent only observes information relevant to the flow it controls, this task is partially observable.

Reinforcement Learning Preliminaries

The task of congestion control may be modeled as a multi-agent partially-observable multi-objective MDP, where all agents share the same policy. Each agent observes statistics relevant to itself and does not observe the entire global state (e.g., the number of active flows in the network).

An infinite-horizon Partially Observable Markov Decision Process (POMDP) may be considered. A POMDP may be defined as the tuple (S, A, P, R). An agent interacting with the environment observes a state sϵ [symbol] and performs an action aϵ [symbol] . After performing an action, the environment transitions to a new state s′ based on the transition kernel P(s'|s, a) and receives a reward r(s, a)ϵR.

In one embodiment, an average reward metric may be defined as follows. Π may be denoted as the set of stationary deterministic policies on A, i.e., πϵΠ then π: [symbol] → [symbol] . Let ρ^{π}ϵ [symbol] be the gain of a policy [symbol] ; defined in state s as:

$${ρ}^{π} ( s ) ≡ {lim}_{T \to ∞} \frac{1}{T} {𝔼}^{π} [ {\sum }_{t = 0}^{T} r ( {s}_{t} , {a}_{t} ) \vert {s}_{0} = s ] ,$$

where [symbol] denotes the expectation with respect to the distribution induced by [symbol] .

One exemplary goal is to find a policy [symbol] * yielding the optimal gain ρ*, i.e.:

for all sϵ [symbol] , [symbol] *(S)ϵarg max_{πϵΠ}ρ^{π}(s) and the optimal gain is ρ*(s)=ρ^{π*}(s). In one embodiment, there may always exist an optimal policy which is stationary and deterministic.

Reinforcement Learning for Congestion Control

In one embodiment, a POMDP framework may require the definition of the four elements in (S, A, P, R). The agent, a congestion control algorithm, runs from within a network interface card (NIC) and controls the rate of the flows passing through that NIC. At each decision point, the agent observes statistics correlated to the specific flow it controls. The agent then acts by determining a new transmission rate and observes the outcome of this action. It should be noted that the POMDP framework is merely exemplary, and the use of other different frameworks are possible.

Observations

As the agent can only observe information relevant to the flow it controls, the following elements are considered: the flow's transmission rate, RTT measurement, and a number of CNP and NACK packets received. The CNP and NACK packets represent events occurring in the network. A CNP packet is transmitted to the source host once an ECN-marked packet reaches the destination. A NACK packet signals to the source host that packets have been dropped (e.g., due to congestion) and should be re-transmitted.

Actions

The optimal transmission rate depends on the number of agents simultaneously interacting in the network and on the network itself (bandwidth limitations and topology). As such, the optimal transmission rate will vary greatly across scenarios. Since it should be quickly adapted across different orders of magnitude, the action may be defined as a multiplication of the previous rate. i.e., rateₜ₊₁=aₜ·rateₜ.

Transitions

The transition sₜ→s′ₜ depends on the dynamics of the environment and on the frequency at which the agent is polled to provide an action. Here, the agent acts once an RTT packet is received. Event-triggered (RTT) intervals may be considered.

Reward

As the task is a multi-agent partially observable problem, the reward must be designed such that there exists a single fixed-point equilibrium. Thus,

$${T}_{t} = - {( target - \frac{{RTT}_{t}^{i}}{base - {RTT}^{i}} \cdot \sqrt{{rate}_{t}^{i}} )}^{2} ,$$

where target is a constant value shared by all flows, base-RTTⁱ is defined as the RTT of flow i in an empty system, and RTTₜⁱ and rateₜⁱ are respectively the RTT and transmission rate of flow i at time t.

$$\frac{{RTT}_{t}^{i}}{base - {RTT}^{i}}$$

is also called the rtt inflation of agent i at time t. The ideal reward is obtained when:

$$target = \frac{{RTT}_{t}^{i}}{base - {RTT}^{i}} \cdot \sqrt{{rate}_{t}^{i}} .$$

Hence, when the target is larger, the ideal operation point is obtained when

$$\frac{{RTT}_{t}^{i}}{base - {RTT}^{i}} \cdot \sqrt{{rate}_{t}^{i}}$$

is larger. The transmission rate has a direct correlation to the RTT, hence the two grow together. Such an operation point is less latency sensitive (RTT grows) but enjoys better utilization (higher rate).

One exemplary approximation of the RTT inflation in a bursty system, where all flows transmit at the ideal rate, behaves like \sqrt{N}; where N is the number of flows. As the system at the optimal point is on the verge of congestion, the major latency increase is due to the packets waiting in the congestion point. As such, it may be assumed that all flows sharing a congested path will observe a similar rtt-inflationₜ

$$\approx \frac{{RTT}_{t}^{i}}{base - {RTT}^{i}} .$$

Proposition 1 below shows that maximizing this reward results in a fair solution:

Proposition 1. The fixed-point solution for all N flows sharing a congested path is a transmission rate of 1/N.

Exemplary Implementation

Due to the partial observability, on-policy methods may be the most suitable. And as the goal is to converge to a stable multi-agent equilibrium, and due to the high-sensitivity action choice, deterministic policies may be easier to manage.

Thus, an on-policy deterministic policy gradient method may be implemented that directly relies on the structure of the reward function as given below. In DPG, the goal may be to estimate ∇_{θ}G^{π}^{_{θ}}, the gradient of the value of the current policy, with respect to the policy's parameters θ. By taking a gradient step in this direction, the policy is improving and thus under standard assumptions will converge to the optimal policy.

As opposed to off-policy methods, on-policy learning does not demand a critic. We observed that due to the challenges in this task, learning a critic is not an easy feat. Hence, we focus on estimating ∇_{θ}G^{π}^{_{θ}} from a sampled trajectory, as shown in Equation (1) below.

$$\begin{matrix}{∇}_{θ} {G}^{{π}_{θ}} = {∇}_{θ} {lim}_{T \to ∞} \frac{1}{T} 𝔼 [ {\sum }_{t = 0}^{T} r ( {s}_{t} , {π}_{θ} ( {s}_{t} ) ) ] \\ = {lim}_{T \to ∞} \frac{1}{T} {\sum }_{t = 0}^{T} {∇}_{a} r ( {s}_{t} , a ) {\vert}_{a = {a}_{t}} \cdot {∇}_{θ} {π}_{θ} ( {s}_{t} ) \\ = {- lim}_{T \to ∞} \frac{1}{T} \\ \cdot {\sum }_{t = 0}^{T} {∇}_{a} {( target - rtt - {inflation}^{i} \cdot \sqrt{{rate}_{t}^{i}} )}^{2} {\vert}_{a = {a}_{t}} \\ \cdot {∇}_{θ} {π}_{θ} ( {s}_{t} ) .\end{matrix} \qquad ( 1 )$$

Using the chain rule we can estimate the gradient of the reward ∇ₐr(sₜ, a), as shown in Equation 2:

∇ₐr(sₜ,a)=(target−rtt-inflationₜ(a)·\sqrt{rateₜ(a)})·∇ₐ(rtt-inflationₜ(a)·\sqrt{rateₜ(a)}). (2)

Notice that both rtt-inflationₜ(a) and \sqrt{rateₜ(a)} are monotonically increasing in a. The action is a scalar determining by how much to change the transmission rate. A faster transmission rate also leads to higher RTT inflation. Thus, the signs of rtt-inflationₜ(a) and \sqrt{rateₜ(a)} are identical and ∇ₐ(rtt-inflationₜ(a)·\sqrt{rateₜ(a)}) is always non-negative. However, estimating the exact value:

∇ₐ(rtt-inflationₜ(a)·\sqrt{rateₜ(a)})

May not be possible given the complex dynamics of a datacenter network. Instead, as the sign is always nonnegative, this gradient may be approximated with a positive constant which can be absorbed into the learning rate, as shown in Equation 3:

$${∇}_{θ} {G}^{{π}_{θ}} ( s ) \approx [ {lim}_{T \to ∞} \frac{1}{T} {\sum }_{t = 0}^{T} ( target - rtt - {inflation}_{t} \cdot \sqrt{{rate}_{t}} ) ] {∇}_{θ} {π}_{θ} ( s ) . \qquad ( 3 )$$

In one embodiment, if rtt-inflationₜ*\sqrt{rateₜ} is above the target, the gradient will push the action towards decreasing the transmission rate, and vice versa. As all flows observe approximately the same rtt-inflationₜ, the objective drives them towards the fixed-point solution. As shown in Proposition 1, this occurs when all flows transmit at the same rate of 1/N and the system is slightly congested.

Finally, the true estimation of the gradient is obtained for T ° °. One exemplary approximation for this gradient is obtained by averaging over a finite, sufficiently long, T. In practice, T may be determined empirically.

Exemplary Hardware Implementation

In one embodiment, an apparatus may include a processor configured to execute software implementing a reinforcement learning algorithm; extraction logic within a network interface controller (NIC) transmission and/or reception pipeline configured to extract network environmental parameters from received and/or transmitted traffic; and a scheduler configured to limit a rate of transmitted traffic of plurality of data flows within the data transmission network.

In another embodiment, the extraction logic may present the extracted parameters to the software run on the processor. In yet another embodiment, the scheduler configuration may be controlled by software running on the processor.

Exemplary Inference in C

In one embodiment, a forward pass may involve a fully connected input layer, an LSTM cell, and a fully connected output layer. This may include the implementation of matrix multiplication/addition, the calculation of a Hadamard product, a dot product, ReLU, sigmoid, and tan h operations from scratch in C (excluding tan h which exists in standard C library).

Transforming the C Code to Handle Hardware Restrictions

In one embodiment, a per-flow memory limit may be implemented. For example, each flow (agent) may require a memory of the previous action, LSTM parameters (hidden and cell state vectors), and additional information. A global memory limit may exist, and no support may exist for float on the APU.

To handle these restrictions, all floating-point operations may be replaced with fixed-point operations (e.g., represented as int32). This may include re-defining one or more the operations with either fixed-point or int8/32. Also, non-linear activation functions may be approximated with small lookup tables in fixed-point format such that they fit into the global memory.

Further, dequantization and quantization operations may be added in code such that parameters/weights can be stored in int8 and can fit into global/flow memory. Also, other operations (e.g., Hadamard product, matrix/vector addition, input and output to LUTs) may be calculated in fixed-point format to minimize precision loss and avoid overflow.

Exemplary Quantization Process

In one exemplary quantization process, all neural network weights and arithmetic operations may be reduced from float32 down to int8. Post-training scale quantization may be performed.

As part of the quantization process, model weights may be quantized and stored in int8 once offline, while LSTM parameters may be dequantized/quantized at the entrance/exit of the LSTM cell in each forward pass. Input may be quantized to int8 at the beginning of every layer (fully connected and LSTM) to perform matrix multiplication with layer weights (stored in int8). During the matrix multiplication operation, int8 results may be accumulated in int32 to avoid overflow, and the final output may be dequantized to a fixed-point for subsequent operations. Sigmoid and Tan H may be represented in fixed-point by combining a look-up table and a linear approximation for different parts of the functions. Multiplication operations that do not involve layer weights may be performed in fixed-point (e.g., element-wise addition and multiplication).

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising, at a device:
training a reinforcement learning agent to perform congestion control within a predetermined data transmission network, utilizing input state and reward values; and
deploying the trained reinforcement learning agent within the predetermined data transmission network.

2. The method of claim 1, wherein the reinforcement learning agent includes a neural network.

3. The method of claim 1, wherein the input state values indicate a speed at which data is currently being transmitted within the data transmission network.

4. The method of claim 1, wherein the reward values correspond to an equivalence of a rate of all transmitting data flows and an avoidance of congestion.

5. The method of claim 1, wherein the reinforcement learning agent is be trained utilizing a memory.

6. A non-transitory computer-readable media storing computer instructions which when executed by one or more processors of a device cause the device to:
train a reinforcement learning agent to perform congestion control within a predetermined data transmission network, utilizing input state and reward values; and
deploy the trained reinforcement learning agent within the predetermined data transmission network.

7. The non-transitory computer-readable media of claim 6, wherein the reinforcement learning agent includes a neural network.

8. The non-transitory computer-readable media of claim 6, wherein the input state values indicate a speed at which data is currently being transmitted within the data transmission network.

9. The non-transitory computer-readable media of claim 6, wherein the reward values correspond to an equivalence of a rate of all transmitting data flows and an avoidance of congestion.

10. The non-transitory computer-readable media of claim 6, wherein the reinforcement learning agent is be trained utilizing a memory.

11. A system, comprising:
a non-transitory memory storage comprising instructions; and
one or more processors in communication with the memory, wherein the one or more processors execute the instructions to:
train a reinforcement learning agent to perform congestion control within a predetermined data transmission network, utilizing input state and reward values; and
deploy the trained reinforcement learning agent within the predetermined data transmission network.

12. The system of claim 11, wherein the reinforcement learning agent includes a neural network.

13. The system of claim 11, wherein the input state values indicate a speed at which data is currently being transmitted within the data transmission network.

14. The system of claim 11, wherein the reward values correspond to an equivalence of a rate of all transmitting data flows and an avoidance of congestion.

15. The system of claim 11, wherein the reinforcement learning agent is be trained utilizing a memory.
